(19) United States
(12) Patent Application Publication
(10) Pub. No.: US 2010/0037138 A1
(43) Pub. Date: Feb. 11, 2010

(54) Client-Configurable Video Delivery Platform

(75) Inventors: Eduard Shcherbakov, Hungtingdon Valley, PA (US); Yury Getsky, Levittown, PA (US)

Correspondence Address: FOX ROTHSCHILD LLP;New York, 2000 Market Street, Tenth Floor, Philadelphia, PA, 19103, US

(73) Assignee: Live Face On Web, LLC, Southampton, PA (US)

(21) Appl. No.: 12/189,616

(22) Filed: Aug. 11, 2008

(51) Int. Cl. G06F 3/048

(52) U.S. Cl. 715/716

(57) ABSTRACT

A video delivery platform includes codec code for decoding video data, video play information access code for obtaining video play information associated with a webpage file, and graphics driver code for presenting one or more video images on the end-user computer according to both the video data and the play information. The video play information may be contained in one or more variables within the webpage file, and permits presentation effects of the video to be changed by simple corresponding changes to the webpage. The video delivery platform may also include a built-in interactive user interface to immediately obtain information from the user.

### FIELD OF THE INVENTION

The present invention relates generally to software video delivery platforms. More particularly, the present invention discloses an interactive video delivery platform for web-based applications that permits a client to configure the manner in which a video is presented and played on an end-user terminal.

### BACKGROUND OF THE INVENTION

The use of multi-media, and video in particular, as an embedded object within a webpage is known. YouTube stands as a significant example of a highly successful website that has capitalized on the public's interest in viewing videos on-line. Videos are also popular in advertising, where they may be embedded within a frame on a third-party webpage.

The presentation of a video necessarily requires the use of a video delivery platform, also known as a video player. These video delivery platforms are typically in the form of an application, such as a JavaScript or Flash program, that is called from the base HTML webpage. The video delivery platform itself may not be hosted by the same server hosting the webpage that, when viewed, causes a video to be displayed. For example, with reference to FIG. 1, a computer system 10 may host a webpage file 14 accessible to an end-user computer 20. A browser 29 on the end-user computer 20 renders the webpage file 14 into a webpage 22. The webpage file 14 is managed by a client 12 and, when rendered, causes a video 24 to be displayed on the end-user computer 20. To present the video 24, the webpage file 14, when processed by the browser 29, may cause a video delivery platform 32 to be downloaded from another system 30 and executed on end-user computer 20. In particular, the end-user computer 20 has a so-called plug-in module 21 that registers and interfaces with the web browser 29. When the web browser 29 recognizes a file type that has been registered by the plug-in module 21, the web browser 29 passes files of this type to the plug-in module 21 for processing. In this manner, the web browser 29 recognizes the file type of the video delivery platform 32 downloaded from server 30, and passes this video delivery platform program 32 to the appropriate plug-in module 21 for execution, which provides on the end-user computer 20 the functionality offered by the video delivery platform 32. This video delivery platform 32 may then itself download or obtain through the browser 29 the data file 42 associated with the video 24 from yet another system 40 and subsequently presents the video 24 in a frame 26 within the webpage 22 on end-user computer 20. It will be appreciated that in many instances one or more of the computer systems 10, 30, 40 may be combined. For example, the computer 40 containing the video data 42 may be the same as the client computer 10.

One problem with this arrangement is that the client 12 has little or no control over how the video data 42 is presented on the end-user computer 20. To date, all video delivery platforms 32 are effectively non-interactive with respect to client 12, and simply play the video data 42 provided by system 40 as-is. Client 12 therefore has little to no control over the look-and-feel of the video data 42 as it is displayed on the end-user computer 20, other than by directly manipulating the video data file 42 itself. Also, the client 12 typically cannot control the configuration and appearance of the video delivery platform 32; the video delivery platform 32 has a set appearance and functionality that is determined exclusively by the system 30.

Another problem with current video delivery platforms 32 relates to customer development issues and so-called “drop off” rates. The business models of many websites rely on obtaining information from end-users. Part of the bait used to initially attract the interest of an end-user may be the presentation of a video. The user may click upon a link near the video, or on the video itself, in response to which the browser may launch another webpage to collect information from the end user. It has been observed that even the slightest delay in the presentation of the data-collection webpage may cause a significant percentage of users to “drop off”—that is, lose interest in the original webpage and hence fail to complete the data-collection webpage. Such drop-off rates are thus a serious concern for website developers.

Accordingly, there is an immediate need for improved video delivery platforms that provide for customization by clients that employ the video delivery platform. Additionally, it would be desirable to have video delivery platforms that may help to lower drop off rates.

### SUMMARY OF THE INVENTION

Various embodiments disclose a computer readable media that encodes a video delivery platform. The video delivery platform includes codec code for decoding video data, video play information access code for obtaining video play information associated with a webpage file, and graphics driver code for presenting one or more video images on the end-user computer according to both the video data and the video play information. In specific embodiments the video play information is contained in one or more variables within the webpage file. In other embodiments the video play information is accessed from anther file, via the Internet, as specified by data within the webpage file.

In certain embodiments the graphics driver code further presents platform controls in accordance with the video play information. In some embodiments the graphics driver code presents a predetermined image when a stop button is activated. The predetermined image is determined by the video play information. In specific embodiments the video play information indicates a frame within the video data that is used as the predetermined image.

In some embodiments the graphics driver code delays presentation of the video images for a predetermined time that is determined by the video play information.

In other embodiments the graphics driver code provides a fade-in or fade-out effect for the video images in accordance with the video play information. The graphics driver code may also determine a time period of the fade-in or fade-out effect according to the video play information. In certain specific embodiments the graphics driver code determines a predetermined image for use in the fade-in or fade-out effect that is obtained in accordance with the video play information.

Some embodiment video delivery platforms may also include steps for closing the video delivery platform after a predetermined time that is determined according to the video play information.

Other embodiment video delivery platforms cause the video delivery platform to not present the video images if the end-user computer is a repeat visitor to the webpage. Yet other embodiments cause the video delivery platform to not present the video images if the end-user computer has previously visited the webpage within a predetermined time. The predetermined time is determined in accordance with the video play information.

Various embodiments of the video delivery platform may further comprise steps for causing the end-user computer to redirect to another webpage that is determined by the video play information. This redirection is caused in response to a triggering event, such as a mouse click on the video. Other embodiments comprise steps for presenting another video, this other video being determined according to the video play information and played in response to a triggering event, such as a mouse click or roll-over event.

Other aspects disclose a computer readable media encoding a video delivery platform. The video delivery platform comprises codec code for decoding video data; graphics driver code for presenting a video on an end-user computer according to the video data and also presenting a user query interface; user query input/output code for obtaining user input through the user query interface to generate user query data; and communications driver code for transmitting the user query data to a second computer.

Certain embodiments may further comprise video play information access code for obtaining video play information associated with the webpage file that causes the video delivery platform to be run on the end-user computer. In such embodiments the graphics driver code presents the video on the end-user computer in accordance with both the video data and the play information. In preferred embodiments, the user query interface is generated in accordance with the video play information.

In other embodiments the communications driver code further obtains data from the second computer, and the graphics driver code presents in the user query interface the data obtained from the second computer.

These and other aspects of the invention shall be more fully detailed in the following written description and figures.

### BRIEF DESCRIPTION OF THE DRAWINGS

FIG. 1 illustrates downloading of a video and video delivery platform when accessing a webpage.

FIG. 2 illustrates downloading of a video and an embodiment video delivery platform.

FIG. 3 is a block diagram of an embodiment web page file.

FIG. 4 illustrates an embodiment method for performing fade-in or fade-out effects.

FIG. 5 illustrates another embodiment video delivery platform.

FIG. 6 illustrates an end-user computer running an embodiment video delivery platform.

### DETAILED DESCRIPTION

For purposes of the following disclosure, the terms “program code,” “code,” “script,” “scripting code” or the like are intended to mean any machine readable set of logical instructions that causes a computer to perform certain specified tasks. Hence, program code may include, for example, machine language and assembly language. It is also intended to more broadly include, however, other software development platforms, such as C++, the .NET framework, JavaScript, Action Script (Flash), HTML and so forth. The terms “run,” “execute,” “process,” “render” and the like are intended to mean that a computer processes the logical instructions present in code to perform the steps indicated by that code and thus provide the functionality intended by that code. Execution of code may be direct, as with machine code, or may be indirect, as with code that is interpreted (such as HTML), compiled (such as C++) or both.

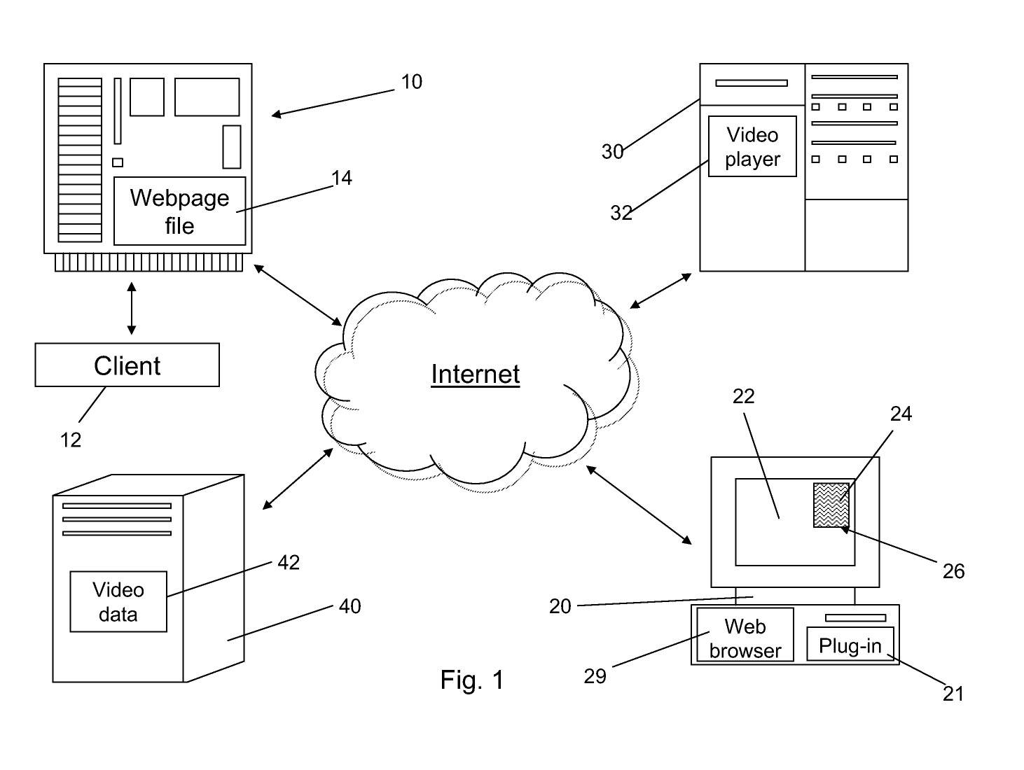

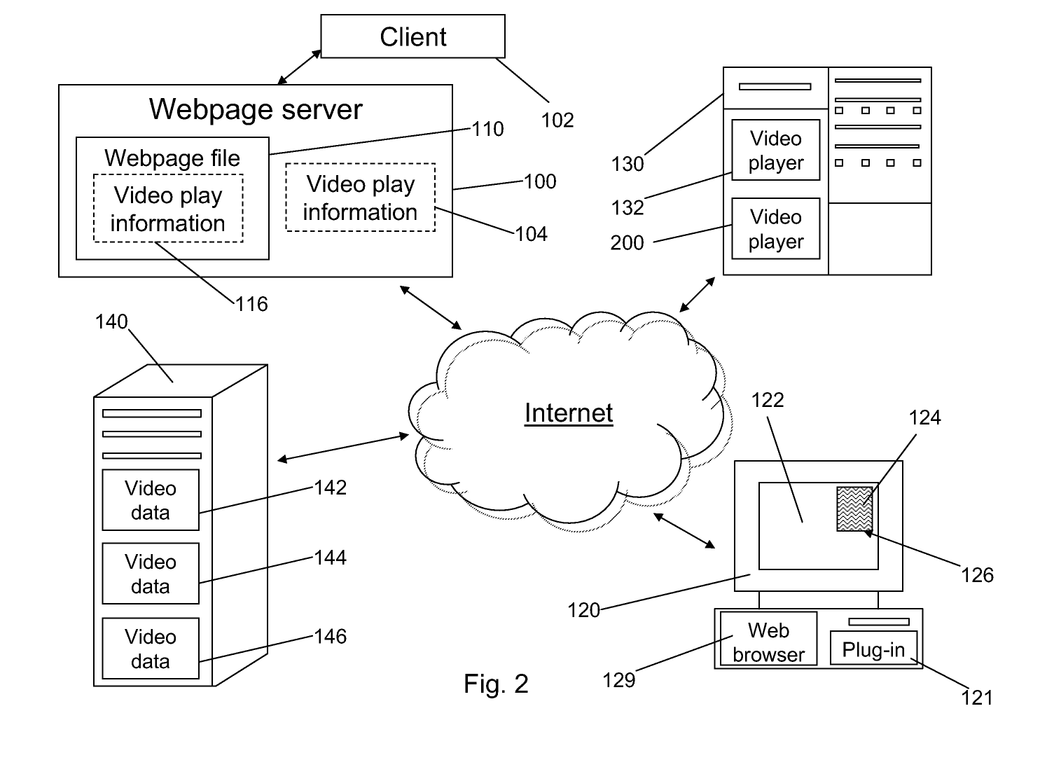

As indicated by FIG. 2, embodiment video delivery platforms 132 and their related methods are similar to those discussed with reference to FIG. 1, but certain embodiment video delivery platforms 132 accept and process video play information 116, 104 contained within, or referenced by, the webpage file 110 to change the manner in which the video data 142 is presented, and hence change the presentation of the video 124 on the end-user computer 120 without the need to change the video data 142 itself. The video play information 116, 104 may also be used to configure the look and feel of the video delivery platform 132, and provide additional client-configurable options for the video delivery platform 132. The video delivery platform 132 may be used to present moving images, still images or both to a user on end-user computer 120.

A platform server 130 contains computer readable media, such as a hard disk, RAM or the like, that stores within a first file (or, optionally, multiple files) program code of an embodiment video delivery platform 132, and transmits in any suitable manner the video delivery platform program code 132 to computer 120. In this manner, the end-user computer 120 obtains the video delivery platform 132 from the first file hosted on the platform server 130. The client computer 100, or a computer controlled by the client 102, meanwhile hosts one or more second files 110, 104 that contain the video play information for the video delivery platform 132. Any suitable method may be employed to provide the end-user computer 120, and specifically the video delivery platform 132, access via the Internet to this video play information hosted by the client computer 100 within the second file(s) 110, 104. In preferred embodiments, the second file storing the video play information is the webpage file 110 itself. In such embodiments, the video play information 116 may be stored within variables set by code, such as JavaScript code, within the webpage file 110; or, the video play information 116 may be passed in the form of one or more parameters in a routine that downloads and runs the video delivery platform 132. In other embodiments, the video play information 104 is stored within one or more files that are each separate from the webpage file 110, and are accessed by the video delivery platform 132 via network calls, such as web service calls, to access the video play information 104. For purposes of this disclosure, it should be understood that the term “access” means obtaining data from a source, such as a file. Hence, downloading an entire file provides access to that file. However, suitable interfaces, such as web-based queries, that provide portions of data present in a file, as known in the art, also provide access to that file.

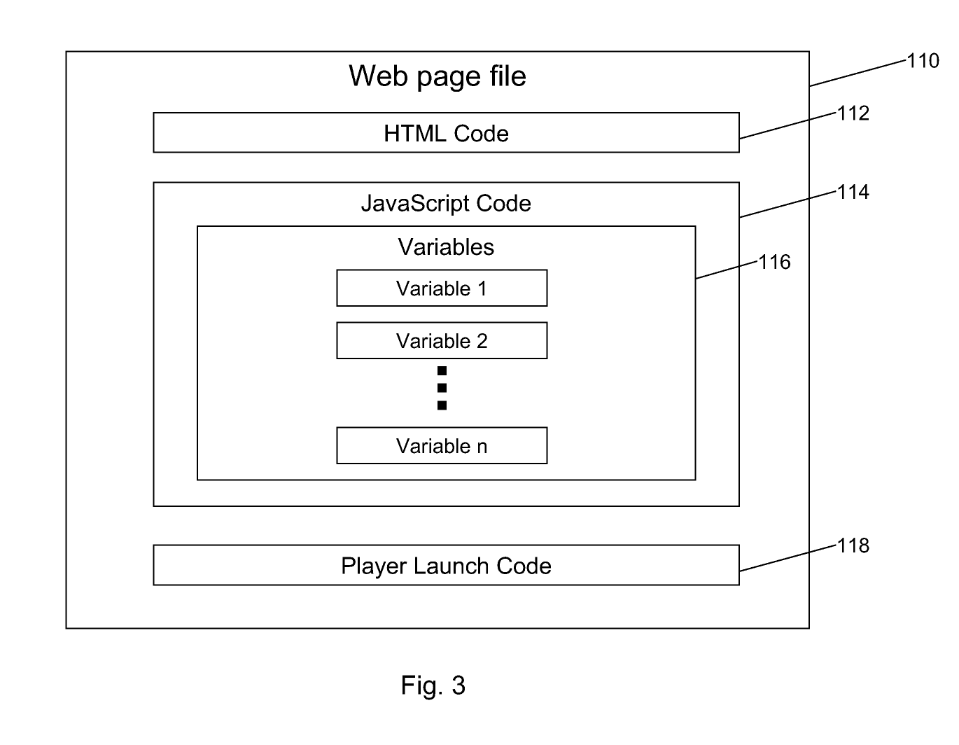

With respect to preferred embodiment client webpage files 110, the webpage file 110 will contain standard scripting code to generate the webpage image 122 on the end-user computer 120, and in particular will contain code that causes the end-user computer 120 to download and run the video delivery platform 132. Specifically, the web browser 129 may pass the obtained video delivery platform code 132 to a suitable plug-in module 121 to provide the requisite embodiment video delivery platform 132 functionality. The plug-in module 121 may be built-in to the web browser 129, such as a plug-in module for JavaScript files, or may be installed by the end-user and registered with the web browser 129, such as for Flash-based files. In such preferred embodiments, the client webpage file 110 will contain internal parameters or variables that are subsequently read by the video delivery platform 132 to control, for example, presentation of the video 124. The client 102 may change these parameters or variables to change the presentation of the video 124. By way of a specific preferred embodiment, as shown in FIG. 3, an embodiment webpage file 110 may include HTML code 112 and JavaScript code 114. The HTML code 112 may be used, for example, to render one or more known elements in the webpage 122. The JavaScript code 114 may include first code in the form of one or more statements that set values for one or more variables 116 in a standard manner that will subsequently be read by the video delivery platform 132 as video play information to control the presentation of video data 142. Additionally, the JavaScript code 114 may, for example, determine the operating system of the end-user computer 120, determine the browser 129 type, listen to browser 129 events, such as scrolling events for the webpage 122, and change the position of a frame 126 within the webpage 122 to provide a “floating” effect for video 124, which plays within the frame 126. In specific preferred embodiments that employ a Flash plug-in 121 to run the video delivery platform 132, the JavaScript code 114 may also verify that the plug-in 121 supports a minimum version of Flash.

The variables 116 provide the video play information that controls the manner in which the video delivery platform 132 presents the video data 142, as well as the look-and-feel of the video delivery platform 132. Because the statements setting the values of the variables 116 are present within the web page file 110 on the client computer 100, which is separate from the file that provided the video delivery platform 132, the client 102 may easily change the statements to change the video play information held by the variables 116, and hence change, for example, the manner in which the video delivery platform 132 presents the video data 142 on the end-user computer 120.

It will be appreciated, however, that the code for the video play information is not limited simply to variables 116 contained wholly within the JavaScript code 114. It may be possible to programmatically provide the video play information by other means. For example, and as alluded to earlier, the video play information may be provided within a parameter string within the webpage file 110 that calls the video delivery platform 132. Simply by way of example, the webpage file 110 may generally be of the form:

```
<HTML>
... {various HTML statements to draw portions of the
webpage 122}
<DIV ... {creates frame 126 within webpage 122}
... {other statements, HTML, JavaScript or the like}
<OBJECT ... > <param name = ‘param1’ value = ‘value1’/>
  <param name = ‘param2’ value = ‘value2’/> ... {calls
  video delivery platform 132 with various parameters
  param1, param2, etc. set respectively to value1,
  value2, etc., which contain the desired video play
  information.}
...
</OBJECT>
...
</DIV>
...
</HTML>
```

Again, as the client 102 hosts the webpage file 110, the client 102 can easily change the parameters set within the <OBJECT> code that causes the video delivery player 132 to be downloaded from the platform server 130 and then run by the plug-in 121. The plug-in 121 provides the video delivery platform 132 access to the contents of the parameters, and hence access to the video play information.

In yet other embodiments, the webpage file 110 may employ one or more variables or parameters as discussed above to provide connection information to the video delivery platform 132. In such embodiments, the client 102 hosts as the second file a separate file 104 on a server, such as the webpage server 100 or even the platform server 130, that contains the video play information. The connection information held by the one or more variables or parameters is used by the video delivery platform 132 to access this file 104 through the Internet, such as by using standard web services, to obtain the video play information. The connection information can be any data that permits the video delivery platform 132 to access through the Internet the second file 104 holding the video play information. For example, it could be the URL of this second file 104. Or, it could be a unique identifier of the second file 104 that, when passed to a suitable query interface as known in the art, responds with the video play information. The connection information present within the webpage file 110 thereby associates the video play information in the second file 104 with the webpage file 110.

1Returning back to the preferred embodiment depicted in FIG. 3, the web page file 110 will also contain platform launch code 118, such as the <OBJECT> code discussed above. The platform launch code 118, when processed by the end-user computer 120, causes the end-user computer 120 to download and run the video delivery platform software 132. The platform launch code 118 thus causes the end-user computer 120 to access a file 132 on the platform server 130 in a standard manner to obtain and run, via either the web browser 129 or the plug-in 121, the video delivery platform 132. The webpage 110 is thereby associated with the video delivery platform 132 when run on the end-user computer 120. In specific embodiments that employ a Flash plug-in 121 to run the video delivery platform 132, because the Flash player 121 is called from the webpage file 110, the running instance of the video delivery platform 132 is thereby associated with the webpage file 110. In preferred embodiments, the platform launch code 118 forms part of the JavaScript code 114 to provide, amongst other issues, “floating” of the frame 126. However, other methods may be used to launch the video delivery platform 132. For example, platform launch code 118 could simply be an <OBJECT . . . > </OBJECT> routine within the HTML code 112 having parameters, as discussed above, that hold the video play information.

The video delivery platform 132 may have many or all of the functionalities provided by a standard video delivery platform. Such functionalities may include, for example, a codec processor for decoding the video data 142, a graphical driver routine that causes the video delivery platform 132 to present the video 124 within the frame 126, a user interface that may optionally permit the user to play, pause or stop the video 124, and so forth. Additionally, however, the video delivery platform 132 will have code that permits the video delivery platform 132 to read the video play information 116, 104 associated with the webpage 110, such as reading the variables 116, reading parameters, or accessing a distinct file 104. Any suitable language may be employed for the video delivery platform 132 so long as such language permits the video delivery platform 132 to access through a network, such as the Internet, the video play information 116, 104 and is preferably supported by a plug-in module 121. Action Script is a preferred language as it is widely supported on end-user computers 120 via a Flash plug-in 121 provided by Adobe Systems, Inc., and offers a host of built-in functions, such as video drivers, user input/output (I/O) controls and forms and events related thereto, web services and the like. In such preferred embodiments, the video delivery platform 132 accesses the video play information stored in JavaScript variables 116 by way of variable pass-through routines provided by the Flash plug-in 121 and as known in the art. Of course, as indicated by other embodiments above, any suitable method may be employed to gain access, via the Internet, to video play information provided by the client 102.

The video play information, such as held by the variables 116, causes the video delivery platform 132 to change the manner in which the video data 142 is processed and the way the video delivery platform 132 operates, and hence the manner in which the video 124 is displayed on the end-user computer 120. That is, the video play information 116, 104 may cause the video delivery platform 132 to augment the video 124 so that the video 124 does not play exactly as defined by the corresponding video data 142. Other types of video play information may change the look-and-feel of the video delivery platform 132. For ease of discussion in the following, specific reference is made to the preferred embodiment that employs variables 116 to hold the video play information. It will be appreciated, however, that any suitable method of storing and accessing the video play information is intended, and hence in the following the term “variable” should simply be understood to be shorthand for specific data within video play information 116, 104 accessed by the video delivery platform 132.

Exemplary variables 116 are described in the following. It will be appreciated that the particular embodiment video delivery platform 132 supporting any such variable 116 would have code associated with such variable 116 to provide the requisite corresponding functionality. Providing the code for such functionality should be well within the means of one having ordinary skill in the art after having the benefit of the instant disclosure.

A first variable 116 may permit the client 102 to select the location at which the video data 142 may be found, such as by providing a suitable URL. After reading this first variable 116, the video delivery platform 132, such as by way of the associated plug-in module 121, will begin downloading the video data 142 from the location indicated by this first variable 116. Alternatively, the browser 129 may use this first variable 116 to obtain the corresponding video data 142 and then provide this video data 142 to the video delivery platform 132. As known in the art, the video data 142 may be a stream, or may be cached on the end-user computer 120.

A second variable 116 may permit the client 102 to select the manner in which the position of the frame 126 is located. Examples include static, relative and dynamic, which may be indicated by any suitable method within the corresponding variable 116. If the client 102 selects static positioning, then the video delivery platform 132 will cause the frame 126 to remain within a fixed position relative to the web page 122. If relative positioning is selected, then the frame 126 is positioned with respect to where the frame 126 is created within the web page file 110. If the client 102 selects dynamic positioning, then the video delivery platform 132 causes the frame 126 to float as the web page 122 scrolls. By way of example, for preferred embodiments that employ JavaScript, the JavaScript can “listen” to scroll-related events occurring in the webpage 122 and adjust the position of the frame 126 in response to such events. Specifically, variables that set the position of the <DIV . . . > code may be modified by the JavaScript to change the position of the frame 126 created by the <DIV . . . > statement.

Third and fourth variables 116 may permit the client 102 to select the offset position of the frame 126. This offset position may indicate, for example, the top, left position of the frame 126, although other computation methods may of course be used. These variables 116 may be used, for example, for static and relative positioning of the frame 126. The units for such offset positions are typically in pixels, although other units may also be used.

A fifth variable 116 may permit the client 102 to select one of several preset positions when dynamic positioning is employed. The video delivery platform 132 may have case parsing code that checks the value of the fifth variable 116 and then causes the video 124 to “float” within the browser screen 122 at the corresponding indicated position. By way of a specific example, the following possible values, and the positions that they respectively indicate, could be:

1=Top left of the browser screen 122

2=Top right of the browser screen 122

3=Bottom left of the browser screen 122

4=Bottom right of the browser screen 122

5=Middle of the browser screen 122

6=Top middle of the browser screen 122

7=Right middle of the browser screen 122

8=Bottom middle of the browser screen 122

9=Left middle of the browser screen 122

Alternatively, it may be possible to use two variables, such as the third and fourth variables 116, that indicate a “float” coordinate within the browser screen 122 for a predetermined location of the video frame 126, for example of the upper left corner of the frame 126. The frame 126 would then “float” relative to this coordinate, keeping the position of the frame 126 within the display relatively constant regardless of whether or not scrolling in the browser screen 122 is performed.

A sixth variable 116 may indicate a delay period of time, as in seconds, that passes before the video delivery platform 132 plays the video 124 within the frame 126. During this delay period, the video delivery platform 132 may optionally present a predetermined image within the frame 126, which will be described later. A delay of zero seconds, for example, may cause the video 124 to play as soon as possible.

A seventh variable 116 may cause the video delivery platform 132 to close after a predetermined time, as in seconds, after the video 124 has completed. For example, if the seventh variable 116 is set to a value of five, the video delivery platform 132 may close five seconds after the video 124 ends. During this time, the frame 126 may present a predetermined image. A predetermined value for the seventh variable 116, such as zero or −1, may disable this function, so that the video delivery platform 132 remains loaded and active even after the video data 142 has been played. In this manner, depending upon the settings of other variables, it may be possible for the end-user to view the video 124 again, if desired.

Visitor tracking for websites is known in the art. Using this technology, it is possible to determine if a visitor to a website is a return visitor, and if so when the last visit occurred, or if the visitor is visiting for the first time. Cookies, for example, are frequently used to perform such visitor tracking functions. The video delivery platform 132 may support such visitor tracking functions, and may use the results of such tracking to determine how the video 124 is presented. For example, an eighth variable 116 may be set to one of several predetermined values, each of which indicates how the video delivery platform 132 should respond to a visitor. For example, if the eighth variable 116 is set to a first value, such as “1”, the video delivery platform 132 may play the video 124 every time for the end-user computer 120, regardless of whether or not this is a repeat visitor. If the eighth variable 116 is set to a second value, such as “2”, the video delivery platform 132 may play the video data 142 only if the visitor is not a repeat visitor. If the eighth variable 116 is set to a third value, such as a “3”, the video delivery platform 132 may play the video data 142 for repeat visitors only if the last visit for such a visitor 120 was more than a predetermined number of hours or days ago. This predetermined time may be set, for example, by a ninth variable 116.

The video delivery platform 132 may support a so-called “click-on-me” redirection functionality. In this case, when an end-user clicks on the video 124, perhaps after being prompted by the video 124, the video delivery platform 132 may interpret this mouse click as a triggering event to cause another webpage to load and display on the end-user computer 120. To enable this functionality, a tenth variable 116 may indicate the URL of the webpage that is to be loaded when the user clicks on the video 124, or within the video frame 126. If this tenth variable 116 is a null string, then the redirection functionality may be disabled. Alternatively, another variable 116 may be used as a Boolean value to indicate if redirection is to be supported, and if so, then the video delivery platform 132 looks to the tenth variable 116 for the location of the target redirection webpage.

If the client user 102 decides to support redirection, then the client user 102 may further set an eleventh variable 116, which may be a Boolean value, to indicate how the target webpage (pointed to by the tenth variable 116) is to be loaded and displayed. If the eleventh variable 116 is set to a first value, such as “True”, then the redirection webpage may be opened in a new browser window; if set to a second value, such as “False”, then the redirection webpage may be opened in the original browser window 122.

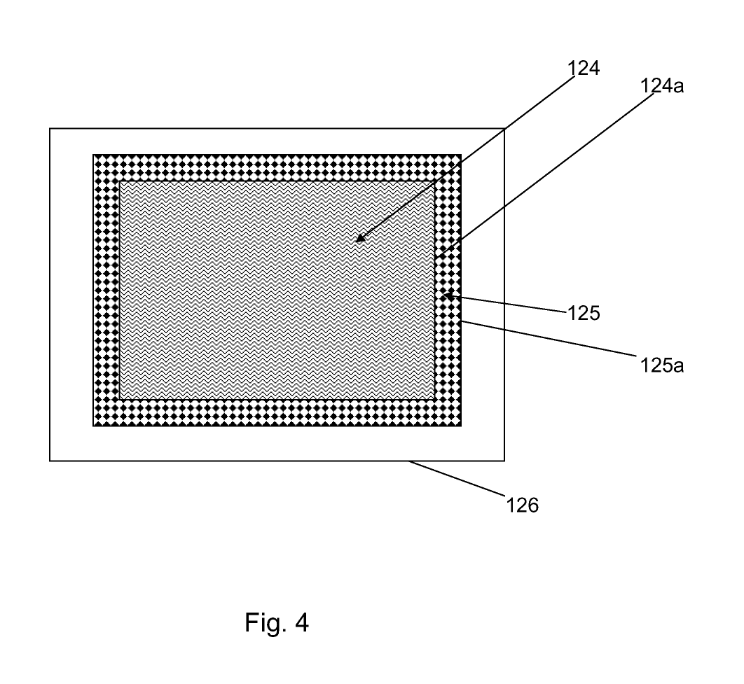

The video delivery platform 132 may also support a fade-in effect for the video frame 126. The video frame 122 may fade into the webpage 122 when a twelfth variable 116 is set, for example, to “True”. The video delivery platform 132 may employ standard graphical routines to cause the video frame 126 to fade into the webpage 122. The fade-in effect causes the video portion of the frame 126 to smoothly transition from a first image to the video image 124 over a predetermined period of time. The images that are presented during this fade-in procedure may be controlled by further variables 116, as discussed below. For example, for specific embodiments that utilize Flash for the video delivery platform 132, Flash supports forms within which an image or video is displayed. As shown in FIG. 4, the Flash itself is contained within the frame 126, and within this frame 126 creates various forms 124a, 125a. The video 124 may be played in a first form 124a, which overlaps on top of a second form 125a. The second form 125a may present a predetermined image 125. The transparency of first form 124a is decreased, over a predetermined time period, from 100 percent to zero to provide a fade-in appearance that fades in from the image 125 to the video 124. Of course, any other suitable method may be employed.

A thirteenth variable 116 may be used to control the time, such as in seconds, over which the fade-in effect occurs. During this period of time, the image presented on the frame 126 corresponding to the video 124 will smoothly transition from a first, predefined image or video to a second image or video, which is typically the video image 124, either still or moving. Alternatively, it may not be necessary to use the twelfth variable 116 if a predefined value for the thirteenth variable is used to indicate whether or not the fade-in effect is to be used, such as zero or −1.

The above second image or video, such as image 125, may be obtained from the video data 142. A fourteenth variable 116 may be used to indicate if the video data 142 is to be played during the fade-in effect, or if a fixed image is to be displayed during the fade-in effect. If, for example, the fourteenth variable 116 is “True”, then the video delivery platform 132 will play the video data 142 while the fade-in effect is occurring. Otherwise, the video delivery platform 132 may, for example, select a predetermined frame from the video data 142 and present this as the second image during the fade-in effect. The video delivery platform 132 may then play the video data 142 after the fade-in effect has completed. Alternatively, the second image may come from a resource within the video delivery platform 132, or may even by accessed from a file over the Internet, using, for example, web services.

A fifteenth variable 116, which may be a set of one or more values, is used to indicate what frame of data in the video data 142 is used during various effects, such as during the delay period discussed above with reference to the sixth variable 116, or the second image presented during the fade-in effect discussed above with reference to the fourteenth variable 116, and during fade-out, control button, and roll-over effects, which are discussed below. A single value maybe used for all of these effects, or a set of values may be used, in which each entry in the set corresponds to one or more effects. For example, if a single value is used and is “7”, then the seventh frame in the video data 142 may be used for delay, fade-in, fade-out, play button, and roll-over effects. Alternatively, a set of values may be used, such as {1, 7, 926, 7, 7}, in which the first frame of data 142 is used during the delay period, the seventh frame of data 142 is used during the fade-in effect, the 926^{th} frame is used during a fade-out effect, and so forth. A predetermined value, such as zero or −1, may be used to disable this function and instead use a predetermined image carried or generated directly by the video delivery platform 132, such as a blank screen. Alternatively, more complicated arrangements may be provided that permit the client 102 to select, for each effect requiring an image, a frame of video data 142, a predefined image carried within the delivery platform 132, nothing at all, or an image accessed over the Internet via, for example, web services or the like.

As indicated above, the platform 132 may also support a fade-out effect, in which the video frame 126 smoothly transitions from a first image, which may be selected from a frame within the video data 142 via the fifteenth variable 116, to a second image, which may be, for example, the corresponding background of the webpage 122, or a predetermined image or color. A sixteenth variable 116 may indicate the duration, such as in seconds, of this fade-out effect. A predetermined value, such as zero or −1, may indicate that the fade-out effect is to be disabled. Alternatively, another variable 116, such as a Boolean, may be used to indicate whether or not the fade-out effect should be employed. With reference to FIG. 4, the fade-out effect may be performed almost identically to the fade-in effect, but with the transparency of the first frame 124a instead transitioning from fully opaque (zero percent) to fully transparent (100 percent).

The video delivery platform 132 may give the client 102 the option of presenting control buttons for the end-user. These control buttons may include, for example, one or more of play, pause and stop buttons, as known in the art, and would typically appear within the frame 126. The control buttons may appear before the video data 142 is played, or after the video data 142 has been played at least once. Additionally, the video delivery platform 132 may permit the client 102 to indicate where the control buttons are to appear on the frame 126. Suitable use of variables 116 may be employed to indicate when and where the platform controls are presented to the end-user. For example, a seventeenth variable 116 may be used to indicated if the play-button controls are to be activated and visible to the end-user, and if so, when. For example, a value of zero may indicate that no play-button controls are to be activated. The user would thus have no control over when and how the video 124 is played. A value of one may indicate that the control buttons are to be presented before the video 124 plays, which may, for example, permit the user to stop the video 124 even before it has begun to play. A value of two may indicate that the controls are to be presented only after the video 124 has finished playing, in which case the user will have to see the video 124 at least once, but could optionally choose to play it again. Similarly, an eighteenth variable 116 may indicate the position of the play button controls, if present. Any number of predefined positions may be supported. Simply by way of example, a value of zero may indicate that the buttons are to appear at the lower left position of the frame 126. A value of one may indicate that the buttons are to appear in the center of the frame 126. Other options and positions are, however, certainly possible. In addition, it should be noted that the platform 132 may use the fifteenth variable 116 discussed above, or the like, to determine what frame of video data 142, or other secondary image, is to be presented when, for example, the end-user clicks upon the “stop” button or, optionally, the “pause” button. The video frames or images used for “stop” and “pause” need not be the same. Typically, however, the frame or image used when the video 124 is paused is the last frame of video data 142 that was presented, rather than a frame selected by the fifteenth variable 116.

The video delivery platform 132 may further support a “roll-over-to-play” functionality that the client 102 may utilize. An embodiment video delivery platform 132 tracks the position of a mouse pointer on the display of the client computer 120 in a standard manner, or waits for corresponding events signaled by, for example, the plug-in 121. When the mouse pointer enters into the video frame 126 this is interpreted as a triggering event to activate the roll-over-to-play functionality, if desired. The roll-over-to-play function causes the video delivery platform 132 to play second video data 144 within the frame 126. The second video data 144 may be cached on the end-user computer 120 prior to playing, or may be downloaded when needed. When the mouse pointer leaves the video frame 126, the video delivery platform may halt playing of the second video data 144 and instead present a predetermined image within the frame 126. This predetermined image may be, for example, a video frame from the first video data 142, as selected, for example, by the fifteenth variable 116, as discussed above. A nineteenth variable 116 may be used to hold the URL of the second video data 144. If this nineteenth variable 116 is null, or another predetermined value, then the roll-over-to-play functionality may be disabled. Alternatively, another variable 116, typically Boolean, may be used to indicate if the roll-over-to-play functionality is to be activated, and if so then the video delivery platform 132 may obtain the URL of the second video data 144 from the nineteenth variable 116.

The video delivery platform 132 may also support client 102 tracking of the behavior of end-user 120. Specifically, the video delivery platform 132 may track the various actions performed by the end user 120, such as movement of the mouse pointer, the number of times the video 124 was played, if the video 124 finished, roll-over events, click events, the control buttons that were clicked and optionally the frame of video data 142, 144 in which they were clicked, and so forth. The end-user behavior data may then be uploaded to the client computer 100, the platform server 130 or any other predetermined server using any standard method. In preferred embodiments, the video delivery platform 132 employs web services or HTTP Post procedures to deliver the end-user behavior data. A twentieth variable 116 may indicate the manner in which such user behavior data is to be supplied to the client computer 100. For example, the twentieth variable may contain a URL address, an identifier or the like so that the video delivery platform knows where to transmit the user-user behavior data. A predefined value for this twentieth variable 116, such as NULL or the like may indicate that such tracking is not to be performed. Alternatively, another Boolean variable 116 may be used to turn such tracking on and off, and if on, then the twentieth variable 116 is used to determine where to send the end-user behavior data.

The video delivery platform 132 may also support looping of sections in the video data 142, which may be controlled by a twenty-first variable 116 that holds a set of values. For example, one value may indicate the start frame in the video data 142 to begin the video loop; another value may indicate the end frame of the loop. The video loop would then be defined by these two values. Alternatively, a value may indicate where to obtain second video data 144 to be played as the video loop. The video delivery platform 132 would then repetitively play as the video 124 the video loop, however defined by the variables 116. Another value could indicate how many times the video loop was to repeat; a predefined value, such as zero, could mean no looping was to occur, thus disabling this video effect, while another, such as −1 could mean to loop forever or until a triggering event occurs. Another value could indicate that the loop is to terminate upon a triggering event, such as a roll-over to play event, a click event or the like, which triggering event may be indicated by the value. Another value could indicate the frame number to begin playing at when the video loop terminates. Yet another value could indicate when video looping is to be performed, such as at video 124 start, after fade-in, during fade-out, when a certain frame number in the video data 142 is reached, when a pause button has been pressed and is thus active, or the like.

A twenty-second variable 116 may activate and control an effect that occurs within the frame 126 around the video 124. For example, the twenty-second variable 116 may instruct the video delivery platform 132 to place a bubble around the video 124.

A twenty-third variable 116, which may include, for example, a set of information pairs, may provide captions as the video 124 is playing. For example, the twenty-third variable 116 may include a set of first and second value pairs for each respective caption to be presented. The first value in each pair indicates the frame number within the video data 142 at which a caption is to be inserted into the frame 126, while a second value may hold the text of the caption. A null set may indicate that no captions are to be presented; alternatively, another variable 116 may be used as a Boolean to indicate whether or not captions are to be provided.

A twenty-fourth variable 116 may be employed to cause the video delivery platform 132 to cause the web browser to make a change within the webpage 122 to attract the attention of the end user. For example, in embodiments that employ JavaScript code 114, a variable within the JavaScript code may control whether or not an object within the webpage 122 is highlighted. Using known techniques, the video delivery platform 132 may change the value of this JavaScript variable to cause the object in the webpage 122 to go from a non-highlighted condition to a high-lighted condition. A twenty-fifth variable 116 may indicate, for example, the frame number within the video data 142, or a time after launching of the video delivery platform 132, at which this event is to occur. For example, the webpage 122 may present a button that, when clicked, redirects the web browser 129 to another webpage. This button may initially be in a non-highlighted condition, as set by a variable in the JavaScript code 114. The video 124 may present an actor saying words to the effect of, “Click on this button to see for yourself!” At the frame number that corresponds to the end of this little speech, the video delivery platform 132 may augment the JavaScript variable to cause the button to become highlighted.

The client 102 may create the webpage file 110, or may be provided a template or example of a web page file 110 by, for example, the platform host 130, which may be inserted into the client's webpage 110. The client 102 may then modify the variables 116 within the webpage file 110 to obtain the desired functionality of the video delivery platform 132 when running on the end-user computer 120. For example, the client 102 may desire a slight delay before the video 124 begins to play, a fade-in effect of about two seconds, and a fade-out effect of about 4 seconds. The client 102 may thus modify variables 116 within the webpage file 110 to obtain these video results and other desired functions, such as by setting appropriate values for the corresponding variables 116, including, for example, the sixth, and twelfth through sixteenth variables 116. The client 102 then hosts this configured webpage file 110 on the client computer 100 so that the end-user computer 120 has access to the webpage file 110. In this manner the client 102 is able to configure both the manner in which the video 124 appears on the end-user computer 120, and the look-and-feel of the video delivery platform 132 as it executes on the end-user computer 120.

A major problem with many website operators, such as the client 102, is end-user 120 drop-off rates when a webpage 110 seeks information from the end-user 120. As previously mentioned, even the slightest delay, such as is typically incurred when redirecting to a new webpage having forms for user input, may cause the end-user 120 to lose interest and browse to another website, thus costing the client 102 a potential customer, revenue or both. To alleviate this problem, various embodiment video delivery platforms include code to immediately provide a query interface with which the client computer 100 may obtain information from the end-user computer 120, and thus reduce drop-off rates. In preferred embodiments, the user I/O interface provided by the video delivery platform may be configured by the client 102. In other embodiments, however, the user I/O interface may be “hardwired” into the video delivery platform.

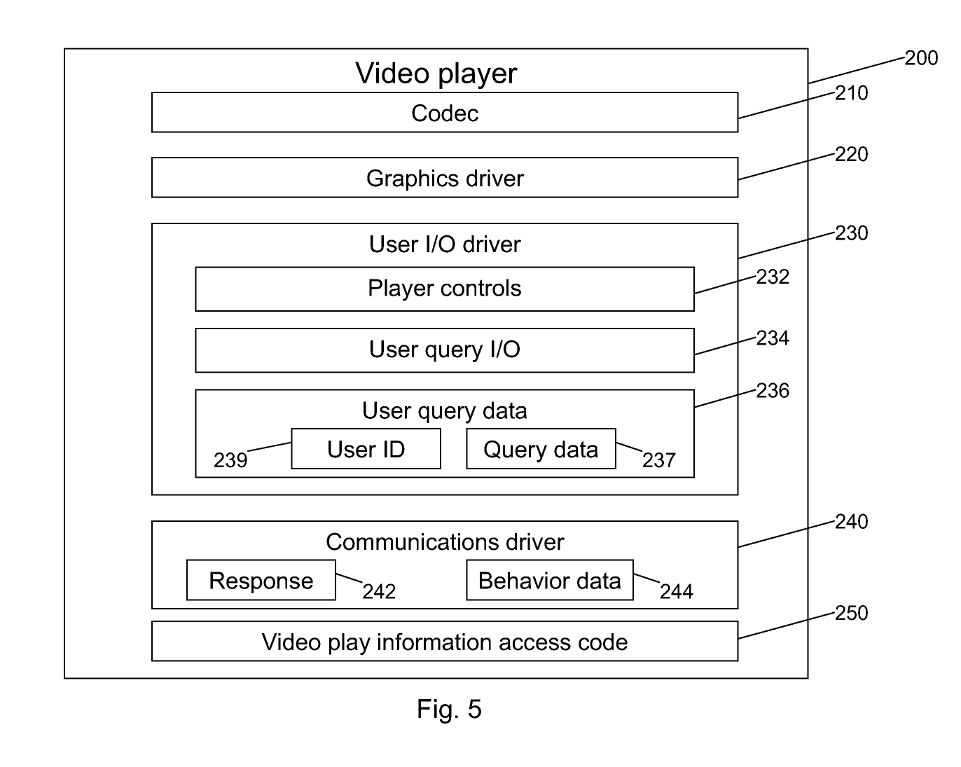

An embodiment video delivery platform 200 is depicted in FIG. 5. The video delivery platform 200 may be coded in any suitable language, such as JavaScript, Action Script, Silverlight or any other suitable web-based programming language. Preferred embodiment platforms 200 are coded in Action Script due to the wide availability of the Flash plug-in 121. The embodiment video delivery platform 200 includes a codec 210, a graphics driver 220, a user input/output (I/O) driver 220, a communications driver 240 and video play information access code 250. Although the blocks in FIG. 5 represent portions of code that together provide the video delivery platform 200, it will be understood that these various blocks do not imply that such code is contiguous within their respective blocks. That is, FIG. 5 simply provides a logical implementation of the video delivery platform 200. The actual implementation is likely to be more convoluted, with, for example, sections of the graphics driver 220 code dispersed throughout the user I/O driver 230 code, sections of the communications driver 240 code present in the user I/O driver 230 code, etc., as is common in the art. Additionally, for embodiments that choose not to implement user I/O functions, the user I/O driver may be omitted, as well as the communications driver code 240 if no tracking data is wanted.

The codec 210 decodes and processes the video data 142, 144, and may support one or more video file formats, known or proprietary. The user I/O driver 230 handles the user interface requirements of the video delivery platform 200, as will be described in more detail later. The graphics driver 220 interfaces with both the codec 210 and the user I/O driver 230 to handle all graphics processing needed for the frame 126 into which the video delivery platform 200 draws. It will be understood that the frame 126 need not be rectangular. The graphics driver 220 may optionally further create one or more other graphics forms into which the video delivery platform 200 may draw. The communications driver 240 interfaces with the user I/O driver 230 to obtain information from the end-user (via, of course, end-user computer 120) and forwards this user information to another computer, typically the client computer 100 or the platform server 130. In preferred embodiments, the communications driver 240 can also receive information from, for example, the client computer 100 and interface with the graphics driver 220 to present corresponding information upon the display of the end-user computer 120. Finally, the video play information access code 250 enables the video delivery platform 200 to access the video play information, such as the variables 116 within the client webpage file 110, as described above. Additionally, in preferred embodiments the video play information access code 250 further obtains information used by the user I/O driver 230 and the graphics driver 220 to generate the user I/O interface.

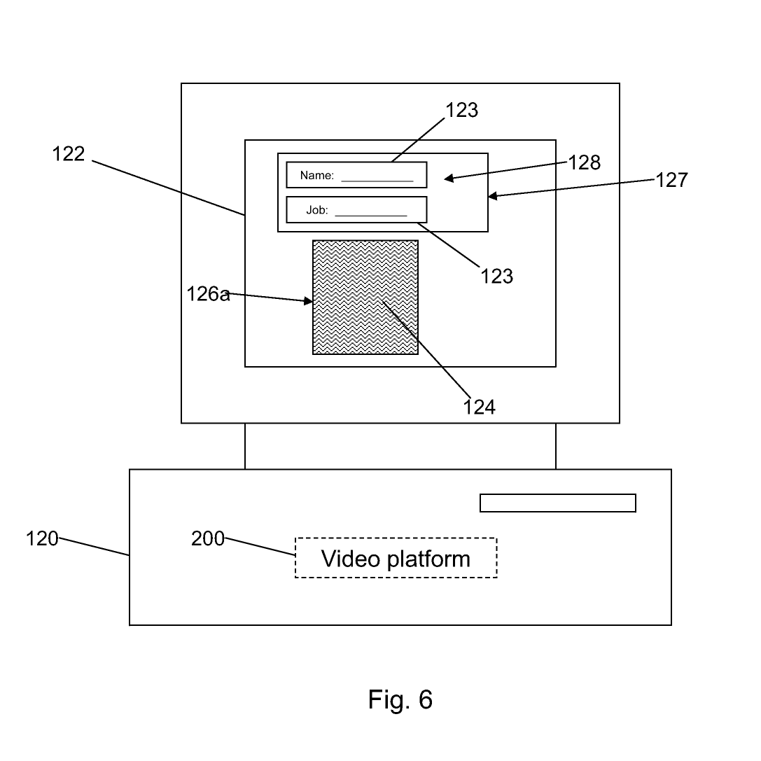

As shown in FIG. 6, and with continuing reference to FIG. 2, in response to executing the client webpage file 110, the end-user computer 120 downloads and runs the video delivery platform 200, for example by way of plug-in module 121. The video delivery platform 200 may be stored on and served by the client computer 100, but in preferred embodiments is served by the platform server computer 130. Once executed, the graphics driver 220 may draw within the frame 126 on the user-computer 120, and using play information obtained by the video play information access code 250, and obtained video data 142, the video delivery platform 200 may present a video 124 within a form 126a within the frame, and optionally player controls 232, in accordance with the video play information.

In addition to optionally providing the player controls 232, as dictated by the play information, in certain embodiments the user I/O driver 230 may also work with the graphics driver 220 to provide user query I/O 234. The graphics driver 220 may open a form 127 within which the user query I/O 234 is processed, which is typically within the same frame 126 as the video form 126a. The user I/O driver 230 may call the user query I/O 234 in response to a triggering event, such as the completion of the playing of video 124, the user clicking on video 124, the user passing the mouse pointer over the video 124, upon initiation of the video 124, etc. The look-and-feel of interface 128 provided by the user query I/O 234, and the event (if any) that triggers launching of the user query I/O 234, may all be controlled by the client 102 by way of corresponding video play information, such as variables 116 within the webpage file 110 or accessed via web service requests, which the video play information access code 250 accesses, parses and passes on to the user I/O driver 230, graphics driver 220 or both. Because the video delivery platform 200 has already launched on the end-user computer 120, processing by the user query I/O 234 is extremely rapid, and may appear almost instantaneous to the end-user after the triggering event, thus reducing the chances of drop-off by the end-user.

After the triggering event, such as a click-on-me event, a roll-over event, video 124 termination or the like, the user query I/O 234 instructs the graphics driver 220 to present the user query interface 128, and then tracks user I/O events within the interface 128. The user query interface 128 may include one or more fields 123 into which the end-user may provide corresponding user data, via, for example, mouse or keyboard events. For example, one field 123 may be a text box or the like that accepts character data (strings) from the end-user. Another field 123 may include one or more checkboxes, radio buttons or the like that the end-user may click upon to indicate corresponding selections. Yet another field 123 may include a drop-down box that enables the end-user to select one of a multiplicity of values or strings. Any other known user I/O object may be used as a field 123 within interface 128. Since all data needed to draw the user query interface 128 is already present on the end-user computer 120, delays typically incurred by network fetches are avoided and so the graphics driver 220 will appear to immediately present the interface 128 in response to the triggering event, thus reducing the chances of user drop-off. Embodiment video delivery platforms 200 also have the unexpected benefit of actually capturing leads that might otherwise be lost due to the highly interactive environment created by the platform 200 with the end-user 120.

In preferred embodiments, the video play information access code 250 provides information that tells the graphics driver 220 and user I/O driver 230 what and where to draw to obtain the desired user query interface 128; this information, in turn, may be configurable by the client 102. For example, the provider of the video delivery platform 200 may specify a predetermined formatting and syntax to specify and position elements used to create a user query interface 128 and code the video delivery platform 200 accordingly. The client 102 need simply follow this formatting and syntax to design and configure the desired user query interface 128. However, in other embodiments the data needed to provide the user query interface 128 may be built directly into the video delivery platform 200.

In response to an input event from the user, such as pressing the “Enter” key on the keyboard, or clicking upon a “Submit” button or the like within the user query interface 128, or operating in parallel with input actions by the user, the user I/O driver 230 generates user query data 236 that corresponds to the data provided by the user when prompted by the query interface 128. The user query data 236 may include a user identifier (ID) 239 and query data 237. The query data 237 may include raw data directly provided by the user, data processed in response to information obtained from the user, or both, and optionally associated tags to identify the data. For example, if the user query interface 128 asks for the first and last name of the end-user, and provides five radio buttons to rank the video 124 just viewed, the query data 237 may include the string “John” for the first name, the string “Doe” for the last name, a value of “3” indicating the user's ranking of the video 124, and optionally any tag identifiers for each of these. The user ID 239 may uniquely identify the user providing the query data 237. In some embodiments, the user ID 239 is generated from a cookie; in other embodiments, the user ID 239 is generated when the video play information access code 250 obtains the video play information. The user query data 236 may also include information identifying the client 102 for whom the data 236 is being collected.

The user I/O driver 230 then provides the user query data 236 to the communications driver 240, which sends information corresponding to the user query data 236 on to another, predetermined computer, such as the client computer 100 or the platform server 130. This computer to which the user query data 236 is sent, and the protocol and related data used, may be determined by the video play information. It will be appreciated that the communications driver 240 may change or augment the user query data 236 to send information corresponding to user query data 236 to the client computer 100. For example, the communications driver 240 may encrypt the user query data 236, and send this encrypted data to the client computer 100. Or, depending upon the communications protocol used, the communications driver 240 may insert data into the user query data 236, or package the user query data 236 into a larger packet. The communications driver 240 may use any suitable signaling protocol to transmit the user query data 236 to the client computer 100. Preferred embodiments transmit the user query data 236 via an HTTP Post procedure. If end-user behavior data 244 is being collected in accordance with the twentieth variable 116, the communications driver 240 may also forward such collected behavior data 244 to the client computer 100. Forwarding may be performed, for example, periodically, such as every 30 seconds; serially as new data comes in; or cumulatively, such as just before the platform 200 closes.

In certain embodiments, in response to the user query data 236 sent to the client computer 100, the client computer 100, or another computer, may send responsive information 242 to the communications driver 240. The communications driver 240 may then forward this response 242 to the user I/O driver 230, which may use the response 242 to cause the graphics driver 220 to fill one or more fields 123 in the user query interface 128. For example, a field 123 in the user query interface 128 may request that the user enter a search string. This search string is passed to the client computer 100 within the user query data 236. In response to receiving the search string, the client computer 100 may perform internal processing, such as a database search, and obtain corresponding results, which are provided to the video delivery platform 200 in a response 242. This response 242 is then used to fill in a “Results” field 123 in the user query interface 128. Hence, embodiment video delivery platforms 200 may support bidirectional communications between the end-user computer 120 and another computer, such as the client computer 100 or the platform server 130.

In certain embodiments, the video delivery platform 200 may determine what video 124 is played in a first form 126a according to user actions performed in the second form 127. For example, the video delivery platform 200 may initially use first video data 142 to play a video 124 in the first form 126a. Subsequently, in respond to a triggering event, such as a mouse click on the first form 126a, the user I/O driver 130 may cause a second form 127 to appear with the user query interface 128. When the mouse pointer rolls over a first field 123, or the user clicks on the first field 129, the user I/O driver 220 may signal to the graphics driver 220 to use second video data 144 to generate a video 124 in the first form 126a, which may, for example, instruct the end-user as to how to fill in the first field 123. When the mouse pointer rolls over a second field 123, or the user clicks on the second field 123, the user I/O driver 230 may instruct the graphics driver 220 to use third video data 146 to play a video 124 in the first form 126a so as to provide instructions to the end-user as to how to fill in the second field 123. The information that controls what video data 142, 144, 146 to play and when may all be specified by the video play information.

By providing video play information that can be configured by the client 102, and by providing a video delivery platform 132, 200 that is capable of reading and acting upon this video play information, the various embodiment video delivery platforms 132, 200 and related methods enable a client 100 to control how a video 124 is played without any need to physically change the corresponding video data 142-146. Moreover, by providing the video delivery platform 200 with user input capabilities and the ability to communicate such user input to the client computer 100, drop-off rates of the end-user may be significantly reduced and capture rates increased.

Although the invention herein has been described with reference to particular embodiments, it is to be understood that these embodiments are merely illustrative of the principles and applications of the present invention. For example, it will be understood that not all embodiments need necessarily make use of all modules shown with respect to the specific embodiment platform 200. For example, some embodiments may forgo the user query I/O 234, but may keep the communications driver 240 to forward behavior data 244 to the client computer 100. Other embodiments may not even use the communications driver 240. In addition, a plethora of other potential video results beyond those disclosed may be supported by embodiment video players. For example, embodiment video players could support insertion of a first video into a predefined position of a second video to provide on-the-fly mixing by the client without the need to actually modify the underlying video files. It is therefore to be understood that numerous modifications may be made to the illustrative embodiments and that other arrangements may be devised without departing from the spirit and scope of the present invention as defined by the following claims.

What is claimed is:

1. A method for providing video to a user computer comprising:
obtaining from at least a first file a video delivery platform for playing a video in accordance with video data and video play information, the video play information indicating one or more effects to be performed when playing the video;
accessing through a network at least a second file comprising the video play information to obtain the video play information;
accessing through the network the video data; and
executing the video delivery platform to play the video in accordance with the video data and one or more effects defined by the video play information.

2. The method of claim 1 wherein obtaining the first file comprises utilizing the network to download the first file from a first server.

3. The method of claim 2 wherein the second file is stored on a second server, the video data is stored on a third server, and at least the first and second servers are different servers.

4. The method of claim 1 wherein the second file is a webpage file comprising first code for setting one or more variables for accessing the video play information and second code to download the first file to obtain and execute the video delivery platform, and the method further comprises the video delivery platform accessing the video play information using the one or more variables.

5. The method of claim 4 further comprising storing the video play information in the one or more variables, and the video delivery platform obtaining the video play information through the one or more variables.

6. The method of claim 5 wherein the first code is JavaScript, and the video delivery platform is an Action Script program employing a variable pass-through routine to obtain data from the JavaScript variables provided by the first code.

7. The method of claim 4 further comprising the video delivery platform obtaining connection information from the one or more variables or parameters and using the connection information to obtain the video play information through the network from a server storing the second file.

8. The method of claim 4 wherein the first file is stored on a first server, the second file is stored on a second server, and the first server is not the same as the second server.

9. The method of claim 1 wherein the second file is a webpage file comprising code for setting one or more parameters for accessing the video play information and for downloading the first file to obtain and execute the video delivery platform, and the method further comprises the video delivery platform accessing the video play information using the one or more parameters.

10. A computer readable media comprising a video delivery platform, the video delivery platform comprising:
codec code comprising steps for decoding video data;
video play information access code comprising steps for obtaining video play information associated with a file that causes the video delivery platform to be downloaded to, run on, or both, an end-user computer; and
graphics driver code coupled to the codec code and the video play information access code and comprising steps for presenting one or more video images on the end-user computer according to both the video data and the play information.

11. The computer readable media of claim 10 wherein the play information is contained in one or more variables within the file.

12. The computer readable media of claim 10 wherein the graphics driver code further comprises steps for presenting player controls according to the play information.

13. The computer readable media of claim 12 wherein the graphics driver code further comprises steps for presenting a predetermined image when a stop button of the player controls is activated, the predetermined image determined by the play information.

14. The computer readable media of claim 13 wherein the play information indicates a frame within the video data to use as the predetermined image.

15. The computer readable media of claim 10 wherein the graphics driver code further comprises steps for delaying presentation of the video images for a predetermined time according to the play information.

16. The computer readable media of claim 10 wherein the graphics driver code further comprises steps for providing a fade-in or fade-out effect for the video images according to the play information.

17. The computer readable media of claim 16 wherein the graphics driver code determines a time period of the fade-in or fade-out effect according to the play information.

18. The computer readable media of claim 16 wherein the graphics driver code determines a predetermined image to use for the fade-in or fade-out effect according to the play information.

19. The computer readable media of claim 10 wherein the video delivery platform further comprises steps for closing the video delivery platform after a predetermined time determined according to the play information.

20. The computer readable media of claim 10 wherein the video delivery platform further comprises steps for causing the video delivery platform to not present the video images if the end-user computer is a repeat visitor.

21. The computer readable media of claim 10 wherein the file is a webpage file, and the video delivery platform further comprises steps for causing the video delivery platform to not present the video images if the end-user computer has previously visited the webpage file within a predetermined time, the predetermined time determined according to the play information.

22. The computer readable media of claim 10 wherein the video delivery platform further comprises steps for causing the end-user computer to redirect to a webpage determined according to the play information in response to a triggering event.

23. The computer readable media of claim 10 wherein the graphics driver code further comprises steps for presenting one or more video images determined according to the play information in response to a triggering event.

24. A computer readable media comprising a video delivery platform, the video delivery platform comprising:
codec code comprising steps for decoding video data;
graphics driver code coupled to the codec code and comprising steps for:
presenting one or more video images on an end-user computer according to the video data; and
presenting a user query interface;
user query input/output code coupled to the graphics driver code and comprising steps for obtaining user input through the user query interface and generating corresponding user query data; and
communications driver code comprising steps for transmitting information corresponding to the user query data through the Internet to a second computer.

25. The computer readable media of claim 24 further comprising video play information access code comprising steps for obtaining video play information associated with a file that causes the video delivery platform to be downloaded to, run on, or both, the end-user computer, and the graphics driver code comprises steps for presenting the one or more video images on the end-user computer according to both the video data and the video play information.

26. The computer readable media of claim 24 wherein the communications driver code further comprises steps for obtaining through the Internet data from the second computer, and the graphics driver code further comprises steps for presenting in the user query interface information associated with the data from the second computer.

27. A method for presenting on an end-user computer a video obtained from video data, the method comprising:
downloading a webpage to the end-user computer;
launching a video delivery platform on the end-user computer in response to execution of the webpage on the end-user computer;
obtaining video play information associated with the webpage; and
the video delivery platform utilizing the video data to present a video on the end-user computer in accordance with the video play information.

28. The method of claim 27 wherein the play information is selected from at least one of a video start delay time, a fade-in effect, a fade-out effect, and an indicator for a predetermined image.

29. A method for providing a client-configurable video delivery platform hosted by a third party computer, the method comprising:
providing a server having one or more files comprising:
video play information; and
one or more steps for causing execution of the video delivery platform on the end-user computer, the video play information being accessible by the video delivery platform when executing on the end-user computer;
configuring the video play information for a desired video result on the end-user computer; and
hosting the one or more files so that the one or more files are accessible to the end-user computer.
